(19) United States
(12) Patent Application Publication
(10) Pub. No.: US 2007/0282617 A1
(43) Pub. Date: Dec. 6, 2007

(54) System, method, and computer program product for forensic auditing

(75) Inventors: Frank Stech, Glenndale, MD (US); Christopher Elsaesser, Reston, VA (US); Kin Sing Leung, Herndon, VA (US); Mark Brown, Arlington, VA (US)

Correspondence Address: STERNE, KESSLER, GOLDSTEIN & FOX P.L.L.C., 1100 NEW YORK AVENUE, N.W., WASHINGTON, DC, 20005, US

(73) Assignee: The Mitre Corporation, McLean, VA (US)

(21) Appl. No.: 11/442,303

(22) Filed: May 30, 2006

(51) Int. Cl. G06Q 10/00; G06Q 30/00

(52) U.S. Cl. 705/1

(57) ABSTRACT

A system and method of determining whether fraudulent accounting activity may have taken place in a business. First, financial data regarding the business is received. A determination is then made as to whether any anomalies are present in the financial data. Such anomalies are referred to herein as “red flags”. Any given red flag may be a manifestation of one or more particular fraud tactics. Conversely, for any particular fraud tactic, a number of associated red flags may be present. For each of a plurality of fraud tactics, the number of red flags associated with the tactic is determined. For each fraud tactic having an associated red flag, a determination is made as to whether the tactic took place in view of the number of red flags that are associated with the tactic. A determination is then made as to whether fraudulent accounting has occurred, based on the number of tactics determined to have taken place. Finally, an indication as to an inference of fraud is generated.

The U.S. Government has a paid up license in this invention and the right in limited circumstances to require the patent owner to license others on reasonable terms as provided for by the terms of purchase order 00489 awarded by the Public Company Accounting Oversight Board of the U.S. Securities and Exchange Commission.

### BACKGROUND OF THE INVENTION

1. Field of the Invention

The invention described herein relates to analysis of financial data, and in particular relates to auditing.

2. Related Art

Fraudulent accounting practices have always been, and continue to be, a fact of life in the business world. Such practices can be costly for shareholders. According to a 2002 government accounting report, the market adjusted return over the three days surrounding the announcement of a restatement to financial statements is associated with an average return of −10%. Fraudulent accounting can also have an impact on the wider economy. It affects the allocation of resources among firms, affects employment, and affects investment. Fraudulent managers may hire and invest too much, distorting the allocation of real resources. During periods of high management fraud, insiders may sell their stocks. Misreporting firms hire and invest like the firms whose income they are trying to match. When they are caught, fraudulent firms shed labor and capital to improve their productivity.

Some of the tactics used in fraudulent accounting are well known. Financial accounts may be manipulated by overstating assets, sales, and profit, or understating liabilities, expenses, or losses. Management fraud is said to occur when a financial statement contains falsifications to such a degree that it intentionally and materially misrepresents the real financial condition of a company.

To detect fraud, the conventional procedure is to audit a company's financial statements. When auditing is performed in order to uncover potential fraud, the practice is known as forensic auditing. Forensic auditing typically requires a human auditor to review all financial information available with respect to a company. This is a slow, labor intensive process. Moreover, the process is information intensive. In addition, because the task is so labor intensive and detail orientated, the process is prone to human error. The auditing process is necessarily limited by the abilities and objectivity of the auditor. The human auditor has cognitive limits and biases that affect the quality of the resulting audit. As a result, research shows that forensic auditors often give fraudulent accounts a “clean” audit. In one study, auditors identified only 43% of the fraud cases, gave 51% of the fraud cases a clean audit, and only had an accuracy rate of 55%.

There is a need, therefore, for a process and system that can quickly detect fraud with a relatively high probability. At a minimum, such a system would provide enough information to guide a human forensic auditor towards specific companies and accounting practices.

### SUMMARY OF THE INVENTION

The invention described herein includes a system and method of determining whether fraudulent accounting activity may have taken place in a business. First, financial data regarding the business is received. A determination is then made as to whether any anomalies are present in the financial data. Such anomalies are referred to herein as “red flags”. Any given red flag may be a manifestation of one or more particular fraud tactics. Conversely, for any particular fraud tactic, a number of associated red flags may be present. For each of a plurality of fraud tactics, the number of red flags associated with the tactic is determined. For each fraud tactic having an associated red flag, a determination is made as to whether the tactic took place in view of the number of red flags that are associated with the tactic. A determination is then made as to whether fraudulent accounting has occurred, based on the number of tactics determined to have taken place. Finally, an indication as to an inference of fraud is generated.

### BRIEF DESCRIPTION OF THE FIGURES

Further embodiments, features, and advantages of the present invention, as well as the operation of the various embodiments of the present invention, are described below with reference to the accompanying drawings.

FIG. 1 is a data flow diagram illustrating the overall processing of an embodiment of the invention.

FIG. 2 illustrates the relationship between fraud, specific fraudulent tactics, and indicators (“red flags”) that can suggest fraudulent tactics.

FIG. 3 is a flow chart illustrating the method of an embodiment of the invention.

FIG. 4 illustrates the computing context of an embodiment of the invention.

### DETAILED DESCRIPTION OF THE INVENTION

An embodiment of the invention is now described with reference to the figures, where like reference numbers indicate identical or functionally similar elements. Also in the figures, the leftmost digit of each reference number corresponds to the figure in which the reference number is first used. While specific configurations and arrangements are discussed, it should be understood that this is done for illustrative purposes only. A person skilled in the relevant art will recognize that other configurations and arrangements can be used without departing from the spirit and scope of the invention. It will be apparent to a person skilled in the relevant art that this invention can also be employed in a variety of other systems and applications.

### Introduction.

The invention described herein includes a system and method of determining whether fraudulent accounting activity may have taken place in a business. First, financial data regarding the business is received. A determination is then made as to whether any anomalies are present in the financial data. Such anomalies are referred to herein as “red flags”. Any given red flag may be a manifestation of one or more particular fraud tactics. Conversely, for any particular fraud tactic, a number of associated red flags may be present. For each of a plurality of fraud tactics, the number of red flags associated with the tactic is determined. For each fraud tactic having an associated red flag, a determination is made as to whether the tactic took place in view of the number of red flags that are associated with the tactic. The number of tactics that are inferred in this manner is then determined. A probabilistic determination is then made as to whether fraud has occurred, based on the number of inferred tactics. Finally, an indication as to the inference of fraud is output.

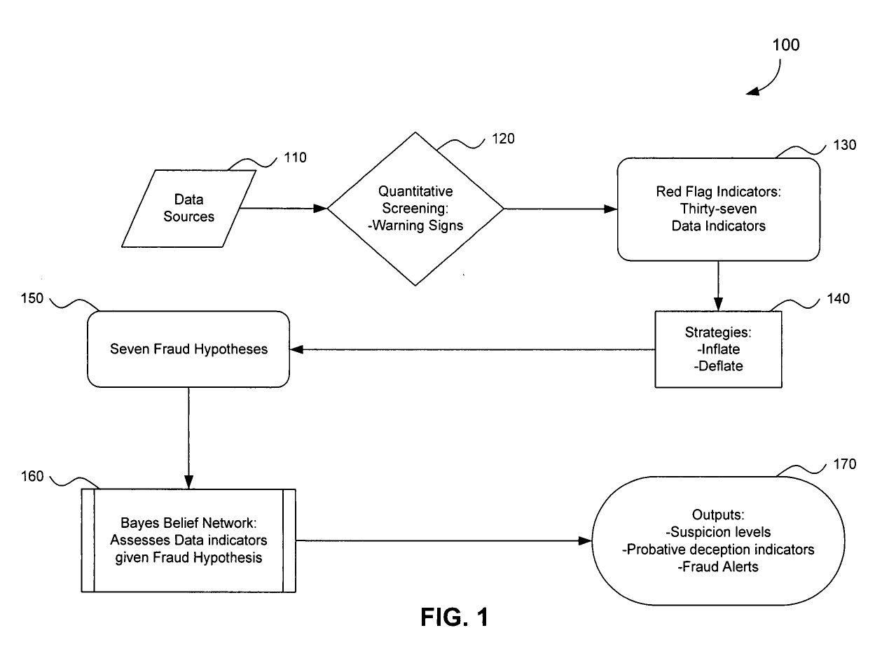

An embodiment 100 of the invention is illustrated generally in FIG. 1. Data sources 110 are used as input for the invention. Such data sources may include publicly available information released by the company in question. Data sources 110 may include quarterly or annual reports, or any other published data that may be required by regulatory organizations such as the Securities and Exchange Commission (SEC) for regulatory purposes, such as 10-K filings. A quantitative screening 120 is then performed. In this screening, data sources 110 are reviewed to determine if they reveal any anomalies. The anomalies of interest are those that might indicate fraudulent accounting practices. Such anomalies can be viewed as warning signs, or “red flags”. The output of quantative screening process 120 is a set of red flag indicators 130. In an embodiment of the invention, there are 37 red flags of interest.

Any given red flag can be a manifestation of one or more fraudulent accounting tactics. Conversely, any given fraudulent accounting tactic may be observed by detecting one or more red flags 130. The red flags 130 suggest the presence of one or more fraud strategies. Such strategies may include the inflating or deflating of particular values, such as accounts receivable, expenses, or deprecation of assets. These strategies 140 can take the form of one or more hypothesized fraud tactics 150.

The set of red flags 130 and indicated fraud tactics 150 are input to a Bayes belief network (BBN) 160. The BBN 160 is used to model the presence of red flags 130, tactics 150 and their inferential relationships. The outputs 170 of BBN 160 can include an indication as to whether fraudulent accounting activity has been taking place. Outputs 170 may take any of several forms, including an indication of suspicion level, one or more indicators of deception, and fraud alerts.

### Data Relationships and the Bayes Belief Network.

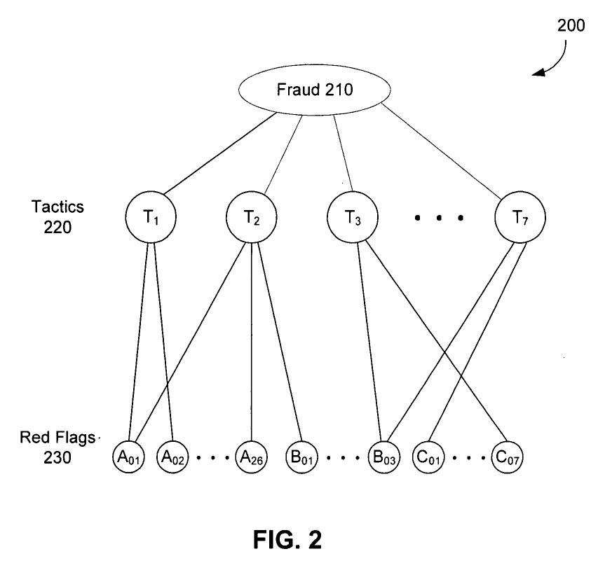

The inferences that are drawn by this invention and the probabilistic relationships between these inferences are modeled in a BBN. An example of a BBN that models such relationships is illustrated in FIG. 2. In this BBN, for a given company being scrutinized, fraud 210 represents a state of having performed fraudulent accounting practices with some probability. In the embodiment illustrated in FIG. 2, fraud 210 represents engaging in one or more specific tactics from a set of tactics 220. In the illustrated embodiment, the set of tactics 220 includes seven specific practices. Examples of such tactics include boosting reported income with one time gains, and shifting current revenue to a later period. Other embodiments of the invention may include more or fewer tactics, and/or may include tactics different from those described herein.

Any given tactic may manifest itself as one or more red flags 230. The red flags 230 represent observations that are made based on available information about the company's finances. As discussed above, such information can be obtained through quarterly or annual reports published by the company, for example. Examples of red flags include cash and equivalents declining relative to total assets, and deferred revenue declining while revenue increases, in an embodiment of the invention. In the embodiment shown in FIG. 2, a tactic T₁ is observed through noticing red flags A₀₁ and/or A₀₂. Tactic T₂ can be manifested in red flags A₀₁, A₂₆, and/or B₀₁. As seen in FIG. 2, any given tactic can be manifested in one or more red flags, while any given red flag can serve as an indicator that one or more specific tactics have been performed.

In an embodiment of the invention, the set of tactics 220 includes the following:
Recording revenue too soon or of questionable quality
Recording bogus revenue
Boosting income with one-time gains
Shifting current period expenses to a later or earlier period
Failing to record (or improperly decreasing) liabilities
Shifting current revenue to a later period, and
Shifting future expenses to the current period.

In an embodiment of the invention, the set of red flags can include, cut is not limited to, the following:
Cash and equivalents decline relative to total assets
Receivables grow substantially faster than sales;
Receivables grow substantially slower than sales;
bad debt reserves decline relative to gross receivables;
Unbilled receivables grow faster than sales or billed receivables;
Inventory grows substantially faster than sales, cost of sales, or accounts payable;
Inventory reserves decline relative to inventory;
Prepaid expenses shoot up relative to total assets;
Other assets rise relative to total assets;
Gross plant and equipment increases sharply relative to total assets;
Gross plant and equipment declines sharply relative to total assets;
Accumulated depreciation declines as gross plant and equipment rises;
Goodwill rises sharply relative to total assets;
Accumulated amortization declines as goodwill rises;
Growth in accounts payable substantially exceeds revenue growth;
Accrued expenses decline relative to total assets;
Deferred revenue declines while revenue increases;
Cost of goods sold grows rapidly relative to sales;
Cost of goods sold declines relative to sales;
Cost of goods sold fluctuates widely from quarter to quarter relative to sales;
Operating expenses decline sharply relative to sales;
Operating expenses rise significantly relative to sales;
Major portion of pretax income comes from one-time gains;
Interest expense rises materially relative to long-term debt;
Interest expense decline materially relative to long-term debt;
Amortization of software costs grows more slowly than capitalized costs;
Cash flow from operations materially lags behind net income;
Company fails to disclose details of cash flow from operations;
Cash inflows come primary from asset sales, borrowing, or equity offerings;
The steepest decline in cash flow from operations relative to net income;
The greatest year-over-year sales growth, followed by declining or negative sequential growth;
The greatest growth in receivables relative to sales;
The largest bulge in inventory relative to sales and to cost of sales;
The biggest or smallest deterioration in gross margins;
Big increases in “soft” assets; and
Big increases in deferred revenue.

### Processing.

In the embodiment of FIG. 2, values are written into the red flag fields 230 and the tactics fields 220 shown in FIG. 2. In an embodiment of the invention, these values are binary. If the financial data for a company reveals the presence of red flag A₀₁, then A₀₁ is given a binary value of true. If red flag A₀₁ is not shown in the financial data, then A₀₁ is assigned a binary value of false. As noted above, a red flag can be observed through a review of a company's public filings and reports (e.g., 10-Q and 10-K reports, and quarterly, semi-annual, and annual reports to shareholders). In alternative embodiments of the invention, the data used can include a firm's known accounting policies, or can also come from questioning of company executives. The data can also come from verbage found in the text of public filings and reports, e.g., a statement that a new accounting firm was hired.

For any given tactic, there is a threshold number of associated red flags which must be true, before that tactic is given a true value. For example, if tactic T₂ has three possible red flags associated with it, two or more may be required to be true before tactic T₂ is indicated (and assigned a value of true). The threshold value may differ from tactic to tactic. Moreover, the threshold numbers may be determined empirically, given known cases of fraud and observed correlations between red flags and tactics.

Similarly, if a threshold number of tactics are true, then fraud is indicated with some probability. Again, the threshold number of tactics required before fraud is inferred may be determined empirically. In addition, the threshold values for both tactics and red flags can be “tuned” in light of additional experience.

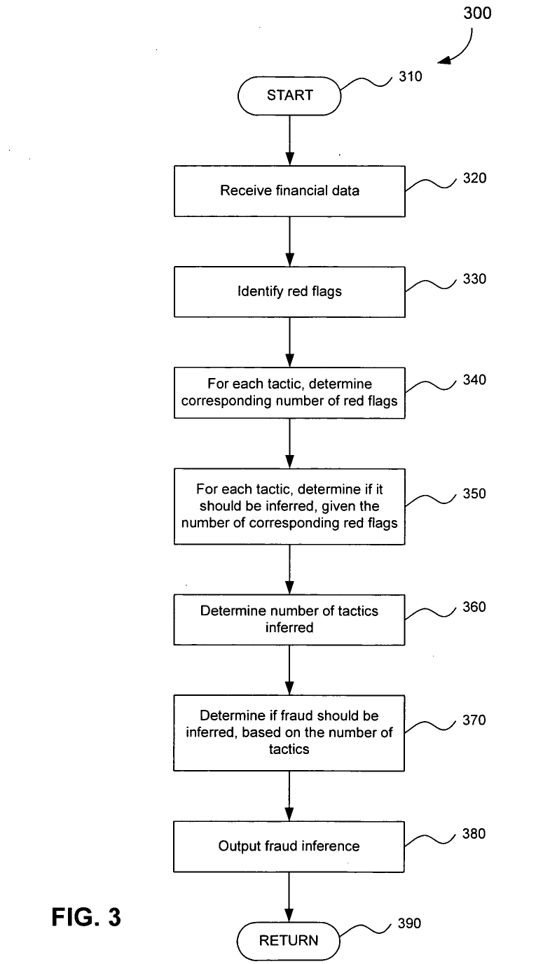

The processing of an embodiment the invention is shown in the exemplary flow chart of FIG. 3. The process starts at step 310. In step 320, financial data for a company is received. As discussed above, such data can include annual reports of a company and/or regulatory filings, such as 10-K reports. In step 330, red flags are identified by reviewing the received financial data. In step 340, for each tactic, the number of associated red flags are determined. In step 350, for each tactic, a determination is made as to whether that tactic should be inferred, give the number of corresponding red flags. In step 360, the number of tactics having a true value is determined. In step 370, it is determined whether fraud should be inferred, based on the number of tactics that are true. In step 380, an inference as to whether or not fraud has taken place is output. The process concludes at step 390.

### Computing Platform

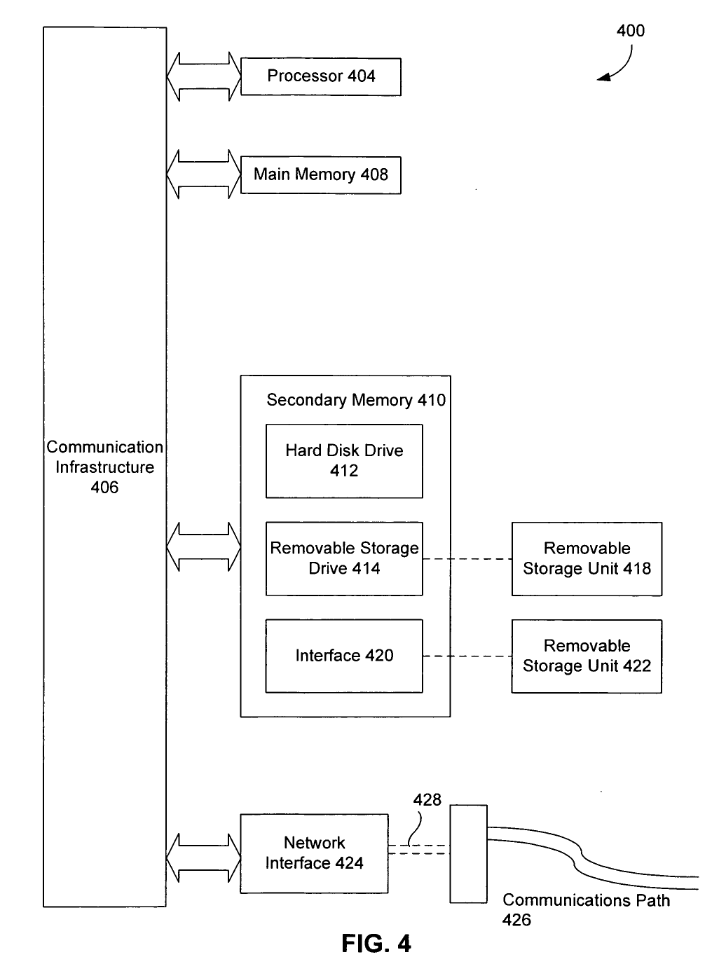

In an embodiment of the present invention, the system and components of the present invention described herein are implemented using well known computers, such as a computer 400 shown in FIG. 4. The computer 400 can be any commercially available and well known computer capable of performing the functions described herein, such as computers available from International Business Machines, Apple, Sun, HP, Dell, Compaq, Digital, Cray, etc.

The computer 400 includes one or more processors (also called central processing units, or CPUs), such as a processor 404. The processor 404 is connected to a communication bus 406. The computer 400 also includes a main or primary memory 408, such as random access memory (RAM). The primary memory 408 may have stored therein control logic (computer software) and data.

The computer 400 also includes one or more secondary storage devices 410. The secondary storage devices 410 include, for example, a hard disk drive 412 and/or a removable storage device or drive 414. The removable storage drive 414 represents a floppy disk drive, a magnetic tape drive, a compact disk drive, an optical storage device, tape backup, etc.

The removable storage drive 414 interacts with a removable storage unit 418. The removable storage unit 418 includes a computer useable or readable storage medium having stored therein computer software (control logic) and/or data. Removable storage unit 418 represents a floppy disk, magnetic tape, compact disk, DVD, optical storage disk, a flash memory device, or any other computer data storage device. The removable storage drive 414 reads from and/or writes to the removable storage unit 418 in a well known manner.

The computer 400 also includes input/output/display devices, such as monitors, keyboards, pointing devices, etc. (not shown).

The computer 400 further includes a communication or network interface 424. The network interface 424 enables the computer 400 to communicate with remote devices. For example, the network interface 424 allows the computer 400 to communicate over communication network 428, such as LANs, WANs, the Internet, etc. The network interface 424 may interface with remote sites or networks via wired or wireless connections.

In an embodiment of the invention, data such as a company's quarterly report or 10-K filing, or information gleaned therefrom, may be input to computer via network interface 424, removable storage units 418 or 422, or through a manual process (e.g., a keyboard). Alternatively, such data can be input through a user interface device (e.g., a keyboard) or other input device, such as a scanner. The input data can then be stored in main memory 408 or in secondary memory 410.

In an embodiment of the invention, the detection of red flags may be performed by computer 400 under the control of control logic that executes on processor 404 after receipt of the input data. Also, the population of a BBN can be performed by computer 400 under the control of control logic that executes on processor 404. Inferences can also be generated by computer 400 under the control of control logic executing on processor 404. Such inferences, as well as red flags, can be output to an input/output device, such as a monitor, main memory 408, or secondary memory 410.

Control logic may be transmitted to and from the computer 400 via the communication medium 428. More particularly, the computer 400 may receive and transmit carrier waves (electromagnetic signals) modulated with control logic via the communication medium 428.

Any apparatus or manufacture comprising a computer useable or readable medium having control logic (software) stored therein is referred to herein as a computer program product or program storage device. This includes, but is not limited to, the computer 400, the main memory 408, the hard disk 412, the removable storage unit 418 and the carrier waves modulated with control logic. Such computer program products, having control logic stored therein that, when executed by one or more data processing devices, cause such data processing devices to operate as described herein, represent embodiments of the invention.

The invention can work with software, hardware, and/or operating system implementations other than those described herein. Any software, hardware, and operating system implementations suitable for performing the functions described herein can be used.

### CONCLUSION

While some embodiments of the present invention have been described above, it should be understood that it has been presented by way of examples only and not meant to limit the invention. It will be understood by those skilled in the art that various changes in form and detail may be made therein without departing from the spirit and scope of the invention as defined in the appended claims. Thus, the breadth and scope of the present invention should not be limited by the above-described exemplary embodiments, but should be defined only in accordance with the following claims and their equivalents.

What is claimed is:

1. A method of determining whether fraudulent accounting activity may have taken place in a business, comprising:
(a) receiving financial data regarding the business;
(b) determining if any red flags are indicated in the financial data;
(c) for each of a plurality of fraud tactics, determining the number of red flags associated with the tactic;
(d) for each fraud tactic with an associated red flag, determining if the tactic may have taken place, on the basis of the number of red flags associated with the tactic;
(e) determining if fraud is inferred, based on the number of tactics determined in step
(d); and
(f) outputting an indication as to an inference of fraud.

2. The method of claim 1, wherein the financial data comprises one or more of:
(a) a 10-K report;
(b) a 10-Q report;
(c) the accounting policies of the business;
(d) results from an interview of an executive of the business; and
(e) a report to shareholders.

3. The method of claim 1, wherein each of the following represents a red flag if indicated in the financial data:
(a) cash and equivalents decline relative to total assets;
(b) receivables grow substantially faster than sales;
(c) the receivables grow substantially slower than the sales;
(d) bad debt reserves decline relative to gross receivables;
(e) unbilled receivables grow faster than the sales or billed receivables;
(f) inventory grows substantially faster than the sales, cost of sales, or accounts payable;
(g) inventory reserves decline relative to the inventory;
(h) prepaid expenses grow substantially faster than the total assets;
(i) individual assets rise relative to the total assets;
(j) gross plant and equipment increases substantially relative to the total assets;
(k) the gross plant and equipment declines substantially relative to the total assets;
(l) accumulated depreciation declines as the gross plant and equipment rises;
(m) goodwill rises substantially relative to the total assets;
(n) accumulated amortization declines as the goodwill rises;
(o) growth in accounts payable substantially exceeds revenue growth;
(p) accrued expenses decline relative to the total assets;
(q) deferred revenue declines while non-deferred revenue increases;
(r) cost of goods sold grows substantially faster than sales;
(s) the cost of goods sold declines relative to the sales;
(t) the cost of goods sold substantially fluctuates quarterly relative to the sales;
(u) operating expenses decline substantially relative to the sales;
(v) the operating expenses rise substantially relative to the sales;
(w) a substantial portion of pretax income comes from one-time gains;
(x) interest expense rises substantially relative to long-term debt;
(y) the interest expense declines substantially relative to the long-term debt;
(z) amortization of software costs grows more slowly than capitalized costs;
(aa) cash flow from operations substantially lags behind net income;
(bb) the business fails to disclose details of the cash flow from the operations;
(cc) cash inflows come primary from asset sales, borrowing, or equity offerings;
(dd) the steepest decline in the cash flow is from operations relative to net income;
(ee) the greatest year-over-year sales growth over time is followed by declining or negative sequential growth;
(ff) the greatest growth over time in receivables relative to the sales occurs;
(gg) a substantial bulge in inventory relative to the sales and to the cost of sales;
(hh) the biggest or smallest deterioration over time in gross margins occurs;
(ii) substantial increases in soft assets; and
(jj) substantial increases in deferred revenue.

4. The method of claim 1, wherein the plurality of fraud tactics comprises one or more of:
(a) recording revenue sooner than normal or recording revenue of indeterminate quality;
(b) recording bogus revenue;
(c) boosting income with one-time gains;
(d) shifting current period expenses to a later or earlier period;
(e) failing to record or improperly decreasing liabilities;
(f) shifting current revenue to a later period; and
(g) shifting future expenses to a current period.

5. The method of claim 1, wherein the indication as to an inference of fraud comprises an electrical signal that indicates whether fraud is inferred.

6. The method of claim 1, wherein said step (b) comprises determining if any red flags are indicated by language in a report issued by the business.

7. The method of claim 1, wherein steps (d) and (e) are performed using a Bayes belief network.

8. A computer program product comprising a computer useable medium having control logic stored therein for causing a computer to determine whether fraudulent accounting activity may have taken place in a business, the computer control logic comprising:
a first computer readable program code means for causing the computer to receive financial data regarding the business;
a second computer readable program code means for causing the computer to determine if any red flags are indicated in the financial data;
a third computer readable program code means for causing the computer to determine the number of red flags associated with a tactic, for each of a plurality of fraud tactics;
a fourth computer readable program code means for causing the computer to determine if the tactic may have taken place, on the basis of the number of red flags associated with the tactic, for each fraud tactic with an associated red flag, a fifth computer readable program code means for causing the computer to determine if fraud is inferred, based on the number of tactics determined in said fourth computer readable program code means; and
a sixth computer readable program code means for causing the computer to output an indication as to an inference of fraud.

9. The computer program product of claim 8, wherein the financial data comprises one or more of:
(a) a 10-K report;
(b) a 10-Q report;
(c) the business' accounting policies;
(d) results from an interview of an executive of the business; and
(e) a report to shareholders.

10. The computer program product of claim 8, wherein each of the following represents a red flag if indicated in the financial data:
cash and equivalents decline relative to total assets;
receivables grow substantially faster than sales;
the receivables grow substantially slower than the sales;
bad debt reserves decline relative to gross receivables;
unbilled receivables grow faster than the sales or billed receivables;
inventory grows substantially faster than sales, cost of sales, or accounts payable;
inventory reserves decline relative to the inventory;
prepaid expenses grow substantially relative to the total assets;
individual assets rise relative to total assets;
gross plant and equipment increases substantially relative to the total assets;
the gross plant and equipment declines substantially relative to the total assets;
accumulated depreciation declines as the gross plant and equipment rises;
goodwill rises substantially relative to the total assets;
accumulated amortization declines as the goodwill rises;
growth in accounts payable substantially exceeds revenue growth;
accrued expenses decline relative to the total assets;
deferred revenue declines while revenue increases;
cost of goods sold grows substantially relative to the sales;
the cost of goods sold declines relative to the sales;
the cost of goods sold substantially fluctuates quarterly relative to the sales;
operating expenses decline substantially relative to sales;
the operating expenses rise substantially relative to sales;
a substantial portion of pretax income comes from one-time gains;
interest expense rises substantially relative to long-term debt;
the interest expense decline substantially relative to the long-term debt;
amortization of software costs grows more slowly than capitalized costs;
cash flow from operations substantially lags behind net income;
the business fails to disclose details of the cash flow from operations;
cash inflows come primary from asset sales, borrowing, or equity offerings;
the steepest decline in cash flow from operations relative to net income;
the greatest year-over-year sales growth over time is followed by declining or negative sequential growth;
the greatest growth over time in receivables relative to the sales occurs;
a substantial bulge in inventory relative to the sales and to cost of sales;
the biggest or smallest deterioration over time in gross margins occurs;
substantial increases in soft assets; and
substantial increases in deferred revenue.

11. The computer program product of claim 8, wherein the plurality of fraud tactics comprises one or more of:
recording revenue sooner than normal or of indeterminate quality;
recording bogus revenue;
boosting income with one-time gains;
shifting current period expenses to a later or earlier period;
failing to record or improperly decreasing liabilities;
shifting current revenue to a later period; and
shifting future expenses to the current period.

12. The computer program product of claim 8, wherein the indication as to an inference of fraud comprises an electrical signal that indicates whether fraud is inferred.

13. The computer program product of claim 8, wherein said second computer readable program code means comprises computer readable program code means for causing the computer to determine if any red flags are indicated by language in a report issued by the business.

14. The computer program product of claim 8, wherein said fourth and fifth computer readable program code means comprise logic for a Bayes belief network.
